(19) United States
(12) Patent Application Publication
(10) Pub. No.: US 2004/0141311 A1
(43) Pub. Date: Jul. 22, 2004

(54) Electroluminescent Frisbee

(75) Inventors: Chung-Jung Chen, Taichung County (TW); Tzu-Kuei Chang, Taichung County (TW); Yang-Chou Lai, Taichung County (TW); Chi-Chen Wu, Taichung County (TW)

Correspondence Address: BACON & THOMAS, PLLC, 625 SLATERS LANE, FOURTH FLOOR, ALEXANDRIA, VA, 22314

(73) Assignee: Chen, Chung-Jung, TAICHUNG COUNTY (TW)

(21) Appl. No.: 10/465,589

(22) Filed: Jun. 20, 2003

(30) Foreign Application Priority Data
Jan. 17, 2003 (TW) 92200862

(51) Int. Cl. F21V 33/00

(52) U.S. Cl. 362/84; 362/253; 446/47

(57) ABSTRACT

An EL Frisbee is composed of a main body and an electroluminescent device. The electroluminescent device includes at least one electroluminescent plate secured on the main body.

### BACKGROUND OF THE INVENTION

1. Field of the Invention

The present invention relates generally to a Frisbee, and more particularly, to an electroluminescent (EL) Frisbee.

2. Description of the Related Art

There are lots of illuminant Frisbees for sale in current mark; some are made of fluorescent materials and absorb light to emit cold light in dark environment; some are provided with a plurality of light-emitting diode (LED) lamps and a battery pack to emit light generated by the LED lamps powered by the battery pack. The aforementioned illuminant Frisbees are able to emit light at night, thereby causing better effects of usage and entertainment.

However, the illuminant Frisbee made of the fluorescent material has insufficient luminance and illuminant duration, thereby causing worse effects of usage and entertainment. The illuminant Frisbee having LED lamps is structurally incompact to cause poor contact between the LED lamps and the power source, and additionally, this Frisbee is structurally complex to have high production cost and poor waterproofness which causes failure of the LED lamps. Furthermore, the illuminant Frisbee having LED lamps is overall weighty to cause worse flying performance.

### SUMMARY OF THE INVENTION

The primary objective of the present invention is to provide an EL Frisbee which has sufficient luminance and illuminant duration.

The secondary objective of the present invention is to provide an EL Frisbee which is structurally compact and preferable for players.

The foregoing objectives of the present invention are attained by the EL Frisbee which is composed of a main body and an electroluminescent device. The electroluminescent device includes at least one electroluminescent plate secured on the main body.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 3 is a transparent top view of the preferred embodiment of the present invention;

FIG. 4 is a sectional view taken along a line 4-4 indicated in FIG. 3; and

FIG. 5 is a sectional view taken along a line 5-5 indicated in FIG. 3.

### DETAILED DESCRIPTION OF THE INVENTION

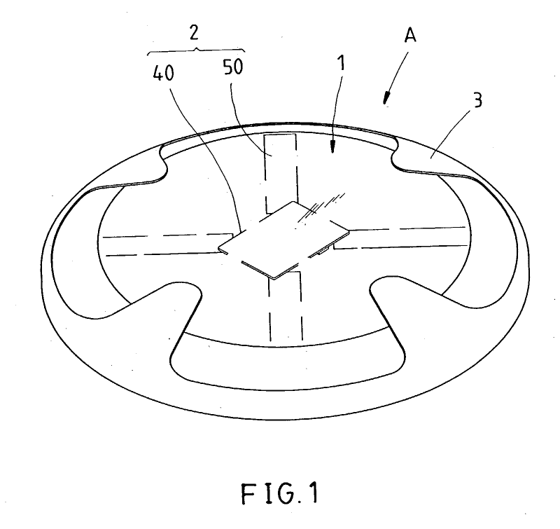

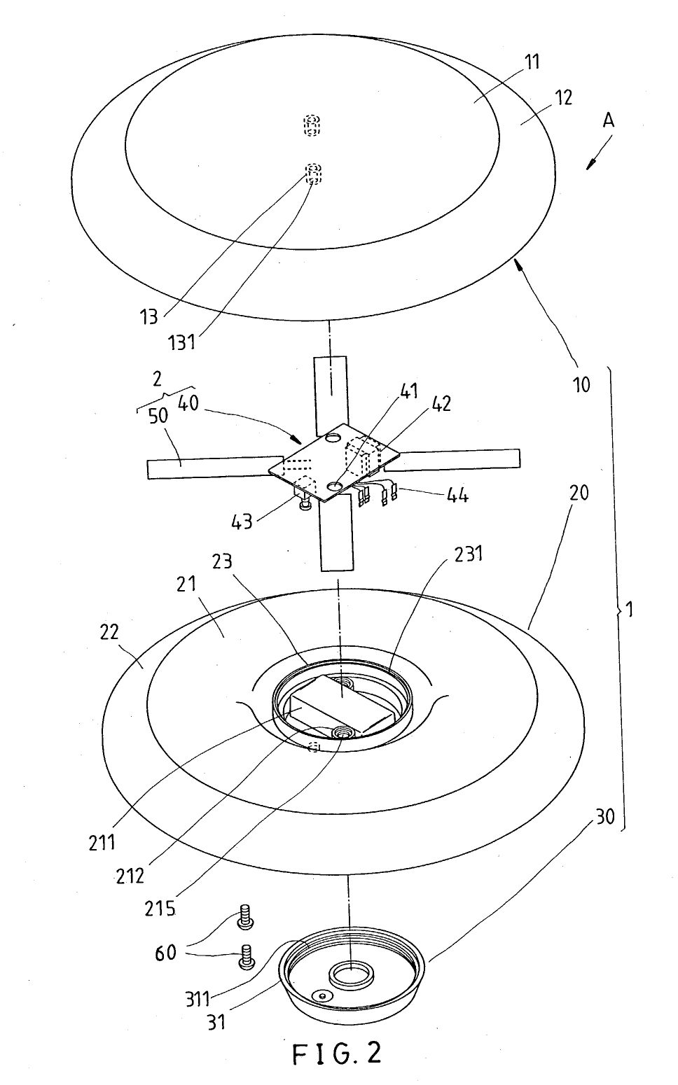

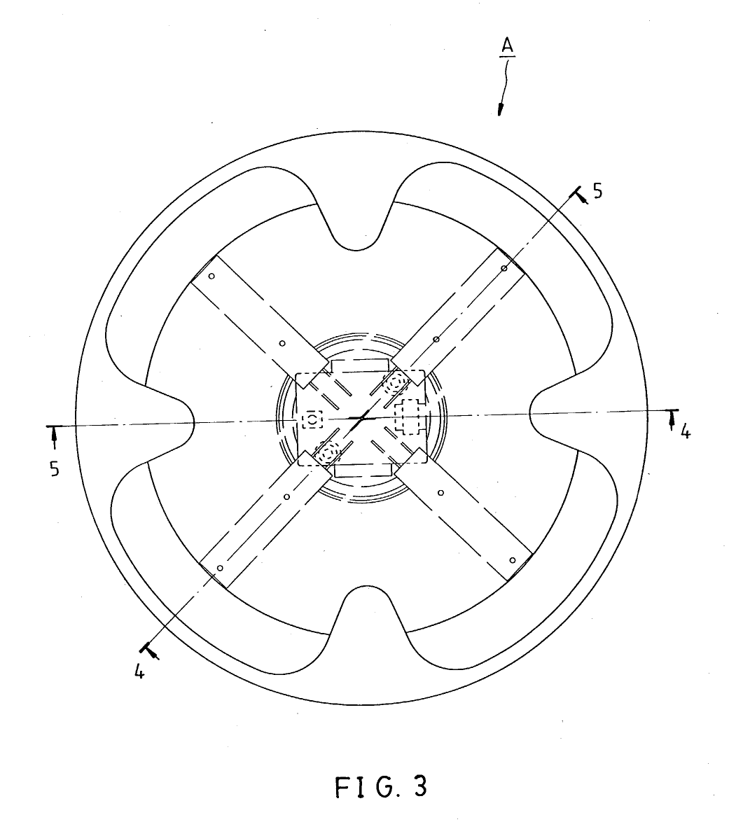

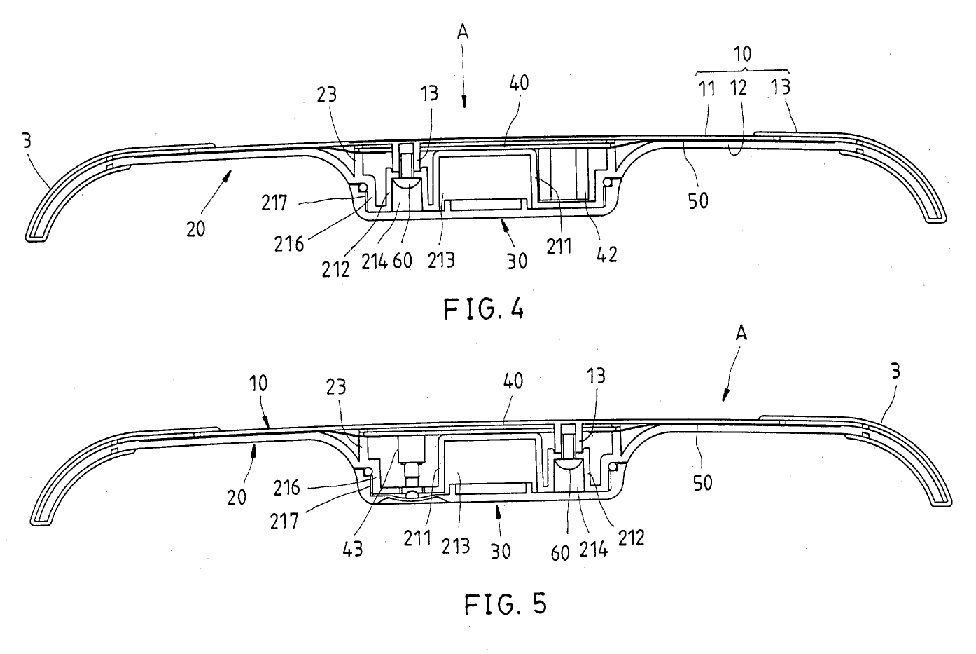

Referring to FIGS. 1-4, an EL Frisbee A of a preferred embodiment of the present invention is composed of a main body 1 and an electroluminescent device 2.

The main body 1 includes a top cover 10, a base 20, and a base cover 30.

The top cover 10 is made of a transparent plastic material of injection molding and is formed of a first body portion 11 shaped like a saucer, a first arched skirt portion 12 extending outwards and downwards from a peripheral edge of the first body portion 11, and two first pillars 13 protruding from a bottom side of the first body portion 11 and having a tapped hole 131.

The base 20 is formed of a second body portion 21, a second arched skirt portion 22, and an annular enclosure 23. The second body portion 21 shaped like a saucer is recessed downwards from the center of a top side thereof and is relatively protruded at the center of a bottom side thereof, at which a battery compartment 211 recessed towards the top side thereof and two second pillars 212 corresponding to the first pillars 13 are formed, thereby respectively defining a battery holder 213 and two screw pits 214, each of which has an opening facing downwards. Each of the second pillars 212 has a through hole 215 running through each of the screw pits 214. The second body portion 21 is provided with a first engaging portion 216 at the protruded center of the bottom side; the first engaging portion 216 has a first thread 217 thereon. The skirt portion 22 extends outwards and downwards from a peripheral edge of the second body portion 21. The annular enclosure 23 extends upward outwards from the recessed center of the top side of the second body portion 21 and having a stepped portion 231 at an inner top edge thereof.

The base cover 30 is formed of a second engaging portion 31 having a second thread 311 for threadedly engaged with the first thread 217 of the first engaging portion 216, such that the base cover 30 is connected to the bottom side of the base 20 to seal the battery holder 213.

The electroluminescent device 2 is formed of a circuit board 40 and four electroluminescent plates 50 which are so-called EL plates. The circuit board 40 has two holes 41 and a control circuit having a transform element 42, a button switch 43, and a plurality of battery contact pins 44; the four electroluminescent plates 50 are electrically connected with the control circuit.

While the present invention is assembled, the circuit board 40 is positioned on the base 20 and within the annular enclosure 23 to enable a bottom side and a bottom peripheral edge of the circuit board 40 to be respectively engaged against a top side of the battery compartment 211 and the stepped portion 231 of the enclosure 23. Align the two holes 41 respectively with the two second pillars 212 and insert the battery contact pins 44 respectively into the battery holder 213 to enable the contact pins 44 to be respectively positioned at two ends of the battery holder 213. The four electroluminescent plates 50 are respectively positioned on a top side of the base 20 and are radially arranged with respect to the center of the base 20.

The top cover 10 is covered on the base 20 to insert the two first pillars 13 respectively into the two holes 41 of the circuit board 40 to be further engaged against the second pillars 212. In the meantime, the circuit board 40 and the electroluminescent plates 50 are respectively positioned between the top cover 10 and the base 20. Two screws 60 are respectively inserted through the two screw pits 214 and respectively into the two through holes 215 to be screwed into the tapped holes 131 of the two first pillars 13, thereby enabling the top cover 10 and the base 20 to be connected with each other and securing the circuit board 40. The base cover 30 is mounted to the bottom side of the base 20 to seal the battery holder 213. Finally, a complete structure of the EL Frisbee A of a preferred embodiment of the present invention is made by a sheathing 3 which is made of a plastic or rubber material of secondary injection molding and is formed around peripheral edges of the top cover 10 and the base 20.

In operation, first, remove the base cover 30, install two small direct-current (DC) batteries into the battery holder 213 by keeping two ends of each battery electrically connected with the battery contact pins 44 of the circuit board 40, and then mount the base cover 30 back to the bottom side of the base 20. After pushing the button switch 43, the control circuit electrically drives the four electroluminescent plates 50 to emit luminescence. In the preferred embodiment of the present invention, the control circuit electrically drives the four electroluminescent plates 50 to emit luminescence irregularly at different intervals. The top cover 10 is made of a transparent material, such that the luminescence emitted by the four electroluminescent plates 50 can transmit through the top cover 10 and the EL Frisbee A is thereby glitteringly luminescent.

In conclusion, the present invention in the preferred embodiment includes advantages as follows.

1. The lighting-emitting plate, which is an illuminant emitting luminescence with stable and uniform luminance in full area thereof for a long time, is well-known to the persons having ordinary skills in this art. Accordingly, the EL Frisbee A has preferable effect of luminescence.

2. The electroluminescent device 2 is mounted between the top cover 10 and the base 20, i.e., the circuit board 40 is respectively contacted against by a top surface of the battery compartment 211 and the annular enclosure 23, is pressured by the top cover 10, and secured by the first pillar 13; the electroluminescent plates 50 are securely oppressed between the top cover 10 and the base 20. Accordingly, the electroluminescent device 2 is preferably fixedly connected in the main body 1. In other words, the EL Frisbee A is structurally strengthened to be durable for longtime use.

3. The EL Frisbee A is encased by the sheathing 3 at the peripheral edges of the top cover 10 and the base 20, and the battery holder 213 is sealed by the base cover 30, such that the EL Frisbee A is preferably waterproof. In addition, the sheathing 3 protects the EL Frisbee A against impacts and shocks. Furthermore, the EL Frisbee A can be versified in appearance.

What is claimed is:

1. A Frisbee comprising:
a main body having a top cover and a base, said top cover and said base being stacked upon and connected with each other, a sheathing being formed around peripheral edges of said top cover and said base, said top cover having at least one transparent portion; and
an electroluminescent device fixedly mounted between said top cover and said base and having at least one electroluminescent plate fixedly mounted under said transparent portion of said top cover.

2. The Frisbee as defined in claim 1, wherein said base comprises a battery holder formed thereon; said electroluminescent device comprises at least one battery and at least two battery contact pins, said battery being installed in said battery holder, said at least two battery contact pins being mounted inside said battery holder and respectively positioned at two ends of said battery holder to electrically connect two electrodes of said battery.

3. The Frisbee as defined in claim 1, wherein said electroluminescent device comprises a circuit board mounted between said top cover and said base, said circuit board having a control circuit electrically connected with said electroluminescent plate.

4. The Frisbee as defined in claim 3, wherein said control circuit further comprises a transform element and a button switch.

5. The Frisbee as defined in claim 2, wherein said battery holder comprises an opening facing downwards, said Frisbee further comprising a base cover connected with said main body to seal said opening of said Frisbee.

6. The Frisbee as defined in claim 1, wherein said top cover comprises two first pillars extending downwards from a bottom side thereof, each of said two first pillars having a threaded hole; said base comprises two second pillars corresponding to said first pillars, each of said second pillars having a screw pit and a through hole running through said screw pit, said two first pillars respectively contacting against said two second pillars, and two screws inserted through said two screw pits and into said threaded holes of said two first pillars to threadedly tightly connect said top cover and said base.

7. The Frisbee as defined in claim 6, wherein said circuit board comprises two holes; said two first pillars are respectively inserted through said two holes to secure said circuit board.

8. The Frisbee as defined in claim 1, wherein said base is recessed downwards at the center of a top side thereof and relatively protrudes downwards at the center of a bottom side thereof, a battery compartment being positioned at said protruded bottom side of said base and recessed towards the top side of said base, and said two second pillars being positioned at said protruded bottom side of said base, thereby respectively defining said battery holder having an opening facing downwards and said two screw pits having an opening facing upwards, each of said two second pillars having a through hole in communication with said screw pit, said base having a first engaging portion at said protruded bottom side thereof, said first engaging portion having a first thread, said Frisbee further comprising a base cover, said base having a second engaging portion, said second engaging portion having a second thread, whereby said base cover is connected with the bottom side of said base to seal said battery holder by said second thread threadedly engaged with said first thread; said top cover comprises two first pillars corresponding to said second pillars, each of said first pillars having a threaded hole, said two first pillars respectively contacting against said two second pillars, and two screws inserted through said two screw pits and into said threaded holes of said two first pillars to threadedly tightly connect said top cover and said base.

9. The Frisbee as defined in claim 8, wherein said base further comprises an annular enclosure extending upwards and outwards from said recessed top side thereof and a stepped portion formed at an inner top edge thereof; said circuit board is positioned on said base and within said annular enclosure and has a bottom side contacting against a top side of said battery compartment, a bottom peripheral edge contacting against said stepped portion of said enclosure, and a top side oppressed by a bottom side of said top cover; said electroluminescent plate is radially arranged on the top side of said base with respect to center of said base.
